(19) United States
(12) Patent Application Publication
(10) Pub. No.: US 2014/0129643 A1
(43) Pub. Date: May 8, 2014

(54) METHOD FOR PROVIDING COLLABORATION SERVICES AMONG PLURAL APPLICATIONS AND COLLABORATION AGENT DEVICE THEREFOR

(71) Applicant: ELECTRONICS AND TELECOMMUNICATIONS RESEARCH INSTITUTE, Daejeon (KR)

(72) Inventors: Chunglae CHO, Daejeon (KR); Sung-Soo KIM, Daejeon (KR); Ji Yeon SON, Daejeon (KR); Jin Tae KIM, Daejeon (KR); Kwang Roh PARK, Daejeon (KR)

(73) Assignee: ELECTRONICS AND TELECOMMUNICATIONS RESEARCH INSTITUTE, Daejeon (KR)

(21) Appl. No.: 14/049,103

(22) Filed: Oct. 8, 2013

(30) Foreign Application Priority Data
Nov. 2, 2012 (KR) 10-2012-0123790
Jul. 2, 2013 (KR) 10-2013-0076924

(51) Int. Cl. H04L 29/06

(52) U.S. Cl. CPC H04L 65/403
USPC 709/205

(57) ABSTRACT

A method for providing collaboration services and a collaboration agent device for implementing the method, which allows the collaboration agent devices to handle common functions necessary for the collaboration services and the applications to indirectly interact with each other using the collaboration agent devices so that applications running executed in two or more smart devices can provide the collaboration services in collaboration with each other.

### RELATED APPLICATIONS

This application claims the benefit of Korean Patent Application Nos. 10-2012-0123790, filed on Nov. 2, 2012 and 10-2013-0076924, filed on Jul. 2, 2013, which is hereby incorporated by reference as if fully set forth herein.

### FIELD OF THE INVENTION

The present invention relates to a method for providing collaboration services between plural applications and a collaboration agent device therefor, and more particularly, to a method for providing collaboration services in which applications running in two or more smart devices collaborate with each other to provide the collaboration services and a collaboration agent device therefor.

### BACKGROUND OF THE INVENTION

As is well known, while increasing personal smart devices that are available in a home network environment or the like, users need to use simultaneously two or more smart devices, trying to use the services. For example, a user tries to watch a VOD video through a smart TV while viewing additional information of the VOD video currently watching using the smart pad, at the same time. At this time, the user hopes to automatically update the additional information in the smart pad, which is appropriate to current contents reproduced from the VOD video, or to play on the smart TV a video that corresponds to contents selected by the smart pad. To achieve the scenario as mentioned above, there needs an interaction between a video application that shows the VOD video on the smart TV and an application for additional information that is required to display additional information in the smart pads.

Following is a description of some conventional techniques for providing a collaboration service between applications being executed in two or more individual smart devices in collaboration with each other like the above described scenario.

First, the conventional technique includes a system having an external server that is placed on the exterior of the system in which each application communicates with the external server to interact indirectly with a counterpart application. This system has a drawback that it innately requires the external server.

Secondly, there is a system in which two applications communicate directly with each other to interact between them. The system has a problem in that the implementation of the applications becomes complex since the applications take charge of a mutual discovery between the applications, address acquisition of counterpart applications, message delivery between the applications, and management of a session that the two applications are commonly participating.

### SUMMARY OF THE INVENTION

In view of the above, the present invention provides a method for providing collaboration services and a collaboration agent device for implementing the method, which allows the collaboration agent devices to handle common functions necessary for the collaboration services and the applications to indirectly interact with each other using the collaboration agent devices so that applications running executed in two or more smart devices can provide the collaboration services in collaboration with each other.

In accordance with a first aspect of the exemplary embodiment of the present invention, there is provided a method of providing collaboration services between a plurality of applications, the method includes: providing, by a first collaboration agent device which is installed in a smart device, a session list in which a first application is able to participate to the sessions, wherein the first application is installed in the same smart device; forwarding, in accordance with a request from the first application to participate in a session selected from the session list, by the first collaboration agent device, the request for a participation in the selected session to a second collaboration agent device, wherein the second collaboration agent device is installed in other smart device; and notifying, by the first collaboration agent device, a result of the request for the participation in the selected session, which is provided from the second collaboration agent device which has decided to admit the participation in the selected session, to the first application.

Further, the method may include after that the second collaboration agent device has decided to admit the participation in the selected session, notifying, by the second collaboration agent device, the second application of the participation of the first application in the selected session.

Further, the method may include discovering, by the first collaboration agent device, that the first application is installed; and notifying, by the first collaboration agent device, the registration of the first application to the second collaboration agent device.

Further, the method may include wherein the first and second applications have information on collaboration sessions, the collaboration session including information about their own applications and sessions in which the applications are able to participate.

Further, the method may include when the first application is installed, requesting, by the first collaboration agent device, the first application of the collaboration session information; receiving, by the first collaboration agent device, the collaboration session information from the first application; and forwarding, by the first collaboration agent device, the collaboration session information to the second collaboration device.

Further, the method may include detecting, by the first collaboration agent device, that the first application is removed from the smart device; and notifying, by the first collaboration agent device, the deregistration of the first application to the second collaboration agent device.

Further, the method may include when the first application is initiated, creating, by the first collaboration agent device, a session for the first application; and notifying, by the first collaboration agent device, to the second collaboration agent device that the session in which the first application participates is created.

Further, the method may include when the first application is completed, deleting, by the first collaboration agent device, the first application from the session to which the first application belongs; and notifying, by the first collaboration agent device, the second collaboration agent device that the first application is deleted from the session in which the first application has participated.

Further, the method may include when the first application requests to withdraw from a session to which the first application belongs, forwarding, by the first collaboration agent device, the request for a withdrawal of the first application from the session to the second collaboration agent device; and when the second collaboration agent device decides the withdrawal of the first application from the session, forwarding, by the first collaboration agent device, the result of the withdrawal from the session to the first application.

Further, the method may include requesting, by the first collaboration agent device, a passage of a message to the second application in accordance with the request of the passage of the message from the first application; and notifying, by the first collaboration agent device, the result of the passage of the message.

In accordance with a second aspect of the exemplary embodiment of the present invention, there is provided a collaboration agent device installed in a smart device, the collaboration agent device being configured to: provide a session list in which an application is able to participate to the sessions, wherein the application is installed in the same smart device; forward, in accordance with a request from the application for a participation in a session selected from the session list, the request to other collaboration agent device, wherein the other collaboration agent device is installed in other smart device; and receive a result of the request for the participation in the selected session from the other collaboration agent device which has decided to admit the participation in the selected session and notify the result of the request for the participation in the selected session to the application.

Further, the collaboration agent device may include a context management unit configured to store, migrate and recover a current state or a current context of the application.

Further, the collaboration agent device may include a lifecycle management unit configured to manage the current state of the application by classifying the current state in any one of a running state, paused state, a migrating state, and a stopped state.

Further, the collaboration agent device may include a migration management unit configured to manage the logical migration of the application from one smart device to other smart device.

Further, the collaboration agent device may include a package management unit configured to manage information about one or more applications installed in the smart device in which the collaboration agent device is equipped.

Further, the collaboration agent device may include a device management unit configured to manage information about the smart device in which the collaboration agent device is installed.

Further, the collaboration agent device may include a message management unit configured to manage that messages are passed between the application and other applications.

In the exemplary embodiment, the collaboration agent device further includes: a session management unit configured to manage information on sessions to which the application and other applications belong.

Further, the collaboration agent device may include a communication management unit configured to manage communications of the collaboration agent device with other collaboration agent devices.

As set forth above, the embodiment of the present invention allows the collaboration agent devices to handle common functions necessary for the collaboration services and the applications to indirectly interact with each other using the collaboration agent devices so that applications running in two or more smart devices can provide the collaboration services in collaboration with each other.

Therefore, it does not require a separate external server and thus it is possible to save the cost required to construct and manage the separate external server. In addition, even when the home network is disconnected with an external network, it is possible to provide the collaboration services.

Further, the embodiment is designed that the collaboration agent devices act on behalf of two or more applications running on different smart devices to perform the functions required for the collaboration services between the applications, which enables developers to focus on the implementation of the original functions of the applications. Consequently, it is possible to implement more easily the applications that provide the collaboration services.

### BRIEF DESCRIPTION OF THE DRAWINGS

The above and other objects and features of the present invention will become apparent from the following description of the embodiments given in conjunction with the accompanying drawings, in which:

FIG. 1 is a configuration diagram of a home network including smart devices equipped with a collaboration agent device in accordance with an embodiment of the present invention;

FIG. 2 is a block diagram of a collaboration agent device in a smart device in accordance with an embodiment of the present invention;

FIG. 3 is a flowchart illustrating an interactive process in which collaboration agent devices make applications to participate in a collaboration session in order to provide a collaboration service in accordance with an embodiment of the present invention;

FIG. 4 is a flowchart illustrating a process of registering an application by collaboration agent devices in accordance with an embodiment of the present invention;

FIG. 5 is a flowchart illustrating a process of unregistering an application by collaboration agent devices in accordance with an embodiment of the present invention;

FIG. 6 is a flowchart illustrating an interactive process performed between collaboration agent devices when starting to run the applications in accordance with an embodiment of the present invention;

FIG. 7 is a flowchart illustrating an interactive process performed between collaboration agent devices when completing applications in accordance with an embodiment of the present invention;

FIG. 8 is a flowchart illustrating an interactive process performed between collaboration agent devices when an application withdraws from a session in which it participates in accordance with an embodiment of the present invention; and

FIG. 9 is a flowchart illustrating an interactive process performed between collaboration agent devices when a message is passed between applications in accordance with an embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, the embodiments of the present invention will be described in detail with reference to the accompanying drawings.

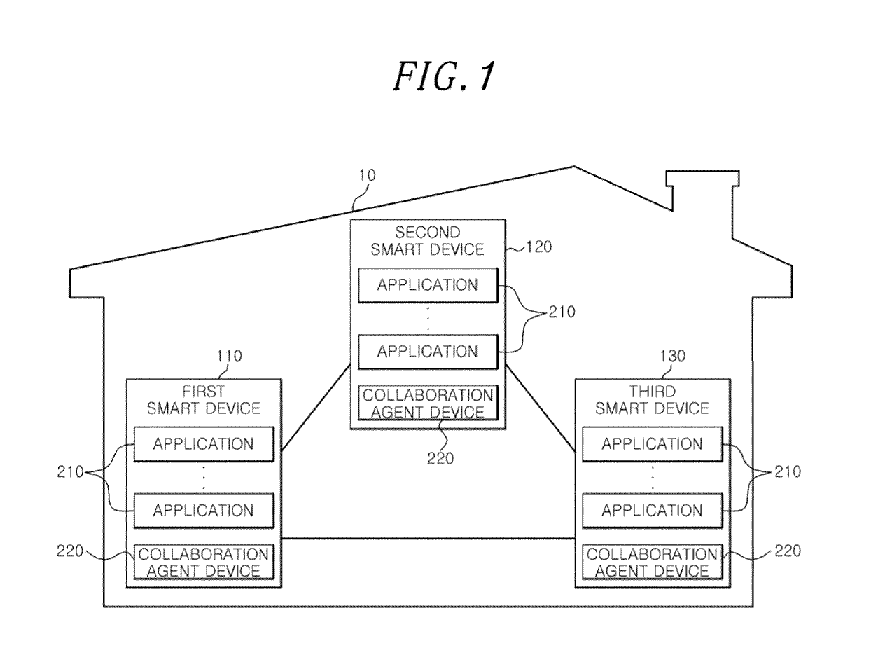

FIG. 1 is a configuration diagram of a home network including smart devices equipped with collaboration agent devices in accordance with an embodiment of the present invention.

As illustrated in FIG. 1, a home network 10 is constituted by a plurality of smart devices including a first smart device 110, a second smart device 120 and a third smart device 130, all of which are equipped with several applications 210. In addition, the first, second, and third smart devices 110, 120 and 130 include collaboration agent devices 220 for collaboration services between the applications 210.

As an example, a collaboration service between the applications 210 is required for providing an N-screen service. During the collaboration service, the collaboration agent devices 220 act the main functions of the applications 210 that are running on different smart devices on behalf of the applications 210.

Each of the applications 210 has information about collaboration session information in order for the collaboration services. The collaboration session information includes information as to whether the application is able to collaborate with any other applications. Specifically, the collaboration session information includes information about the application itself and information about sessions in which the application is able to participate. The information about the application itself includes information about an ID of the application, a name of the application, a version of the application, an execution environment of the application, and the like. In addition, the information about sessions in which the application is able to participate includes IDs or categories of applications that are able to collaborate, dependency information for the applications, the number of instances of the applications that are able to participate in a session and the like.

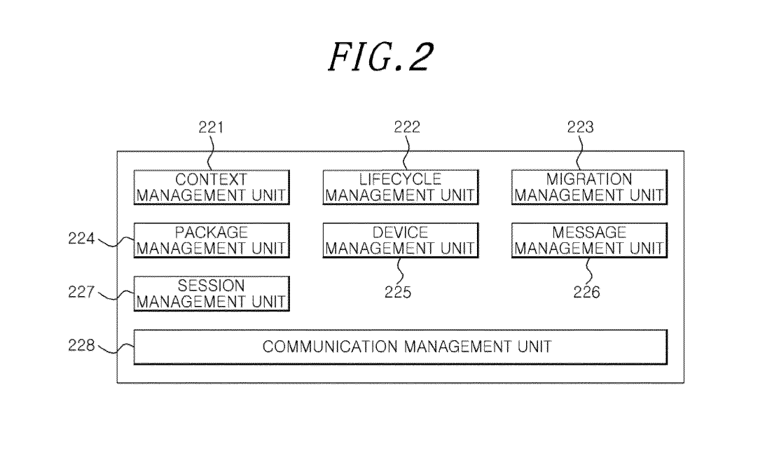

FIG. 2 is a block diagram of a collaboration agent device in a smart device in accordance with an embodiment of the present invention. As illustrated in FIG. 2, a collaboration agent device 220 includes a context management unit 221, a lifecycle management unit 222, a migration management unit 223, a package management unit 224, a device management unit 225, a message management unit 226, a session management unit 227, and a communication management unit 228.

The context management unit 221 serves to provide functions to store, migrate and recover a current state, i.e., a current context of the applications. For example, when a user who uses an application in a first smart device desires to continue to use the application in a second smart device, the context management unit 221 supports to store current state information of the application, migrate the state information from the first smart device to the second smart device, and recover a state for the application when the application is run in the second smart device.

The lifecycle management unit 222 manages the current state of the respective applications by classifying the current state in any one of a running state, paused state, a migrating state, and a stopped state.

The migration management unit 223 manages the logical migration of the applications from one smart device to other smart devices.

The package management unit 224 manages information about the applications installed in the smart device equipped with the collaboration agent device.

The device management unit 225 manages information about the smart device equipped with the collaboration agent device.

The message management unit 226 manages that messages are passed between one application and other application. An application uses a logical ID of a counterpart application instead of a physical address of the counterpart application when it sends a message to the counterpart application. The message management unit 226 comprehends a physical address to which the message is to be forwarded (i.e., an address of a counterpart smart device on which a counterpart application is running) and transmits the message to a collaboration agent device in the corresponding smart device.

The session management unit 227 manages information about sessions to which applications in a smart device and other applications in other smart devices belong.

The communication management unit 228 manages communications of a collaboration agent device with other collaboration agent devices. This communication management unit 228 promotes the collaboration agent device on the home network, actively finds out other collaboration agent devices on the home network, and exchanges control messages and event messages between the collaboration agent devices.

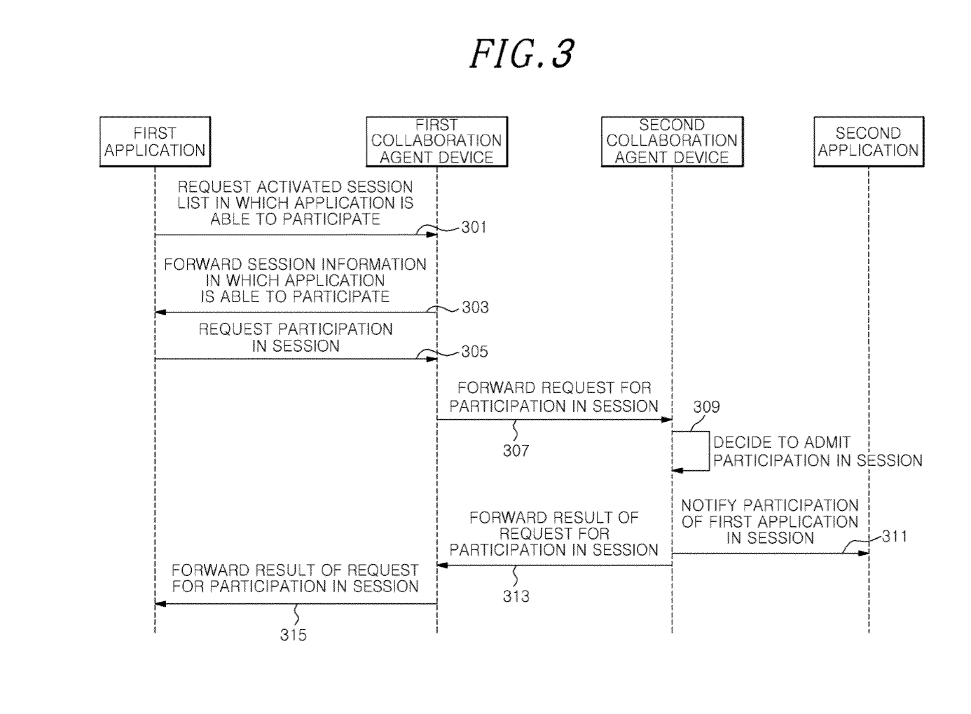

FIG. 3 is a flowchart illustrating an interactive process in which the collaboration agent devices make the applications to participate in a collaboration session in order to provide a collaboration service in accordance with an embodiment of the present invention.

First, a first application makes a request to a first collaboration agent device for an activated session list in which the first smart device is able to participate, in an operation 301, and the first collaboration agent device then sends information containing the session list in which the first smart device is able to participate in the first application, in an operation 303, wherein the first application and the first collaboration agent device are installed in the same smart device.

Subsequently, the first application selects a session from the session list and requests a participation in the selected session, in an operation 305. The first collaboration agent device then sends the request for the participation of the first application in the selected session to a second collaboration agent device that is installed in other smart device, in an operation 307.

In response thereto, the second collaboration agent device decides whether to admit the participation of the first application in the selected session, in an operation 309. In the operation 309, the second collaboration agent device may decide on its own whether to admit the participation of the first application in the selected session on behalf of a second application or may decide whether to admit the participation of the first application in the selected session depending on a response from the second application after querying to the second application.

Thereafter, the second collaboration agent device informs the second application of the participation of the first application in the selected session, in an operation 311. Further, the second collaboration agent device forwards the result of the request of the participation in the selected session to the first collaboration agent device, in an operation 313.

The first collaboration agent device then forwards the result of the request for the participation in the selected session to the first application, in an operation 315.

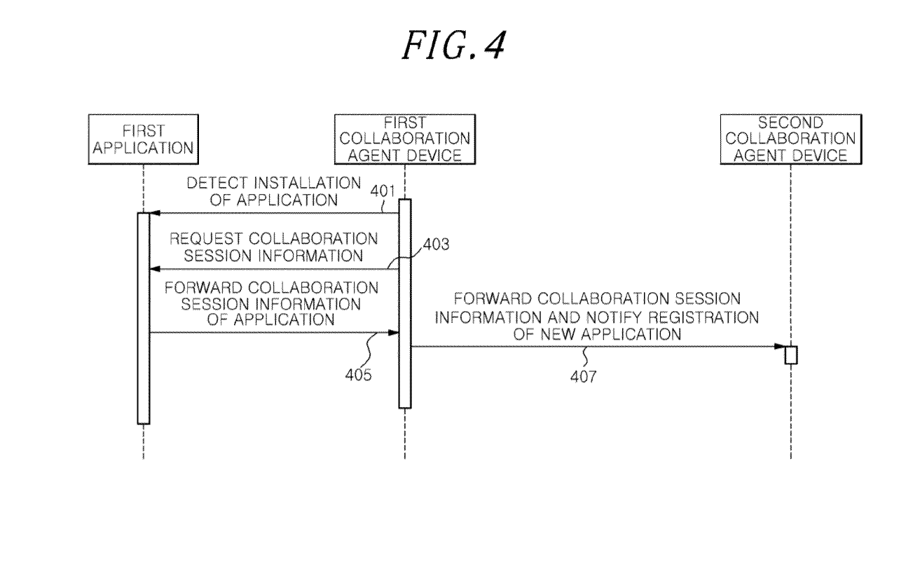

FIG. 4 is a flowchart illustrating a process of registering an application by collaboration agent devices in accordance with an embodiment of the present invention.

When a first application is installed in a smart device, a first collaboration agent device which is equipped in the same smart device detects and discoveries the presence of the first application, in an operation 401; and requests for information on collaboration sessions to the first application, in an operation 403.

The first application forwards the collaboration session information to the first collaboration agent device, and the first collaboration agent device receives the collaboration session information from the first application, in an operation 405; and the first collaboration agent device then forwards the collaboration session information to the second collaboration agent device and notifies the registration of the first application, in an operation 407.

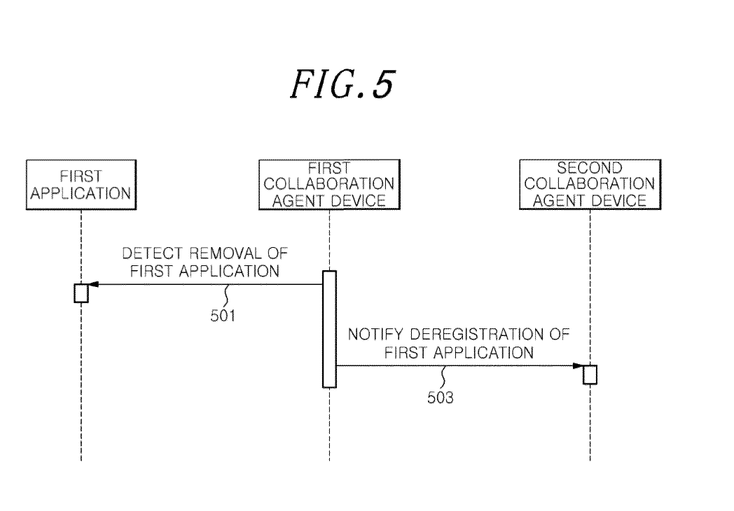

FIG. 5 is a flowchart illustrating a procedure of unregistering an application by collaboration agent devices in accordance with an embodiment of the present invention.

When a first application is removed from a smart device, a first collaboration agent device which is installed in the same smart device detects the removal of the first application, in an operation 501; and notifies the deregistration of the first application to the second collaboration agent device, in an operation 503.

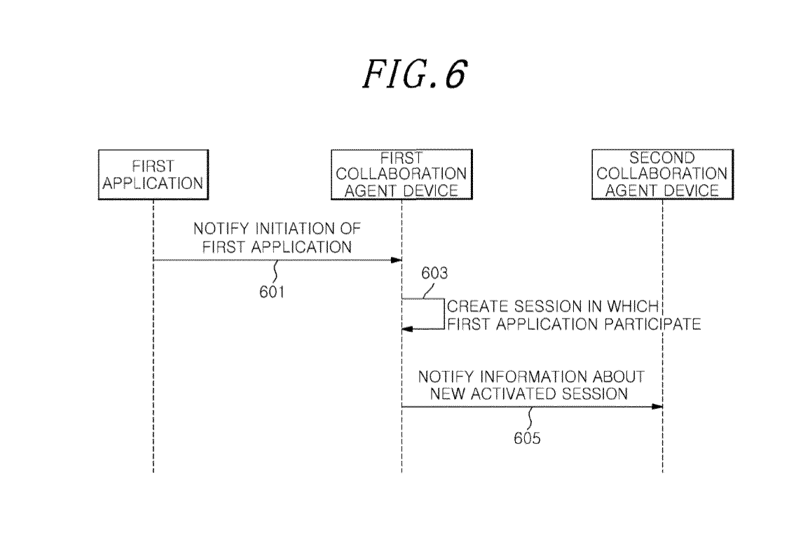

FIG. 6 is a flowchart illustrating an interactive process performed between collaboration agent devices when starting applications in accordance with an embodiment of the present invention.

When a first application is initiated, the first application notifies its own activation to the first collaboration agent device, in an operation 601; and the first collaboration agent device creates a session for the first application, in an operation 603. Further, the first collaboration agent device notifies a second collaboration agent device that the session in which the first application participates is created, in an operation 605.

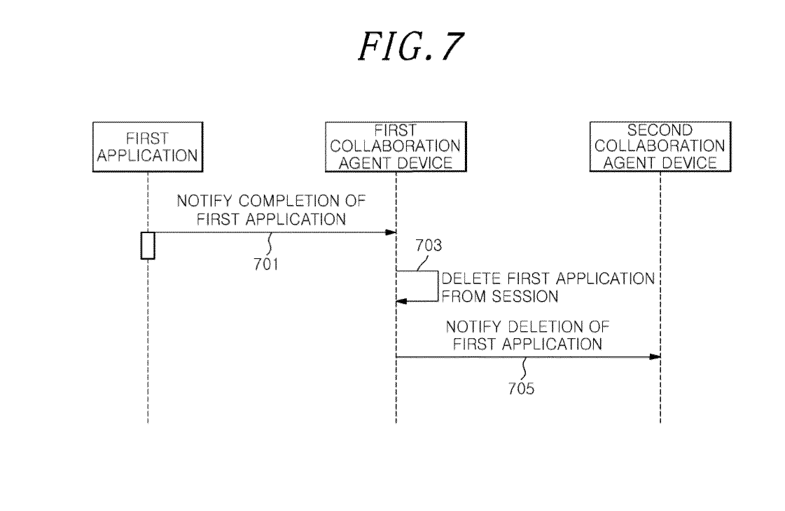

FIG. 7 is a flowchart illustrating an interactive process performed between collaboration agent devices when completing an application in accordance with an embodiment of the present invention.

When a first application is complete, the first application notifies its completion to the first collaboration agent device, in an operation 701; and the first collaboration agent device deletes the first application from a session in which the first application participates, in an operation 703. The first collaboration agent device then notifies to the second collaboration agent device that the first application is deleted from the session in which the first application has participated, in an operation 705.

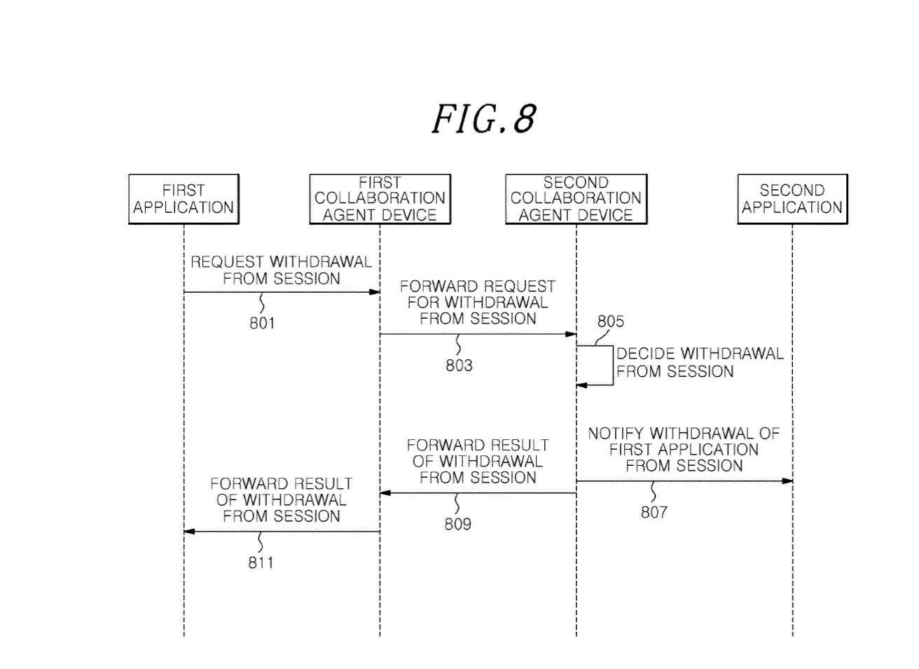

FIG. 8 is a flowchart illustrating an interactive process performed between collaboration agent devices when an application withdraws from a session in which it participates in accordance with an embodiment of the present invention.

The first application requests a first collaboration agent device to withdraw from a session to which it belongs, in an operation 801; and the first collaboration agent device then forwards the request for a withdrawal of the first application from the session to a second collaboration agent device, in an operation 803.

The second collaboration agent device decides the withdrawal of the first application from the session, in an operation 805; and then notifies the withdrawal of the first application from the session to the second application, in an operation 807.

In addition, the second collaboration agent device forwards the result of the withdrawal of the first application from the session, which has been decided in the operation 805, to the first collaboration agent device, in an operation 809; and the first collaboration agent device then forwards the result of the withdrawal from the session to the first application, in an operation 811.

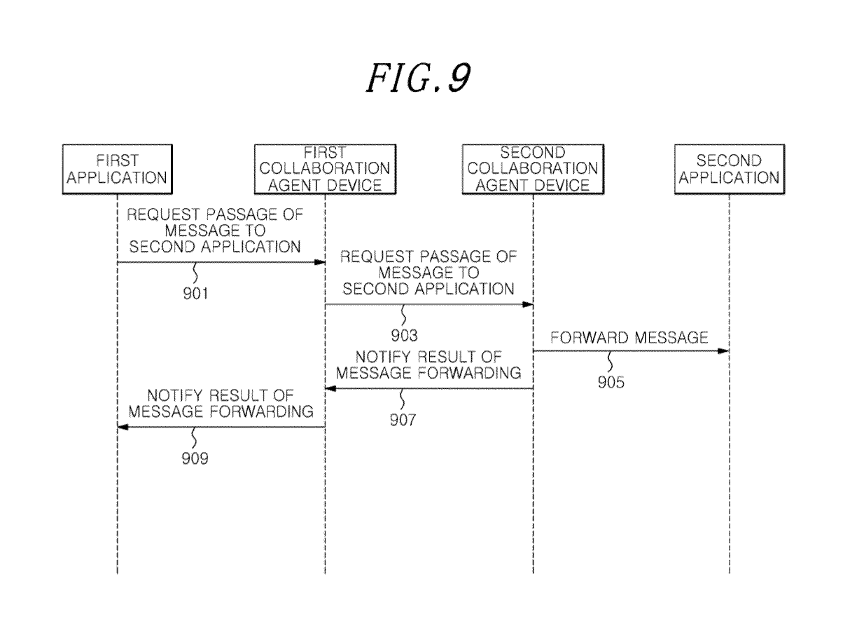

FIG. 9 is a flowchart illustrating an interactive process performed between collaboration agent devices when a message is passed between applications in accordance with an embodiment of the present invention.

The first application request a first collaboration agent device to pass a message to a second application, in an operation 901; and the first collaboration agent device then requests a second collaboration agent device to pass the message to the second application, in an operation 903.

The second collaboration agent device then forwards the message from the first application to the second application, in an operation 905. In addition, the second collaboration agent device notifies the first collaboration agent device of the result of the forwarding of the message, in an operation 907; and the first collaboration agent device notifies the first application of the result of the forwarding of the message, in an operation 909.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method of providing collaboration services between a plurality of applications, the method comprising:
providing, by a first collaboration agent device which is installed in a smart device, a session list in which a first application is able to participate to the sessions, wherein the first application is installed in the same smart device;
forwarding, in accordance with a request from the first application to participate in a session selected from the session list, by the first collaboration agent device, the request for a participation in the selected session to a second collaboration agent device, wherein the second collaboration agent device is installed in other smart device; and
notifying, by the first collaboration agent device, a result of the request for the participation in the selected session, which is provided from the second collaboration agent device which has decided to admit the participation in the selected session, to the first application.

2. The method of claim 1, further comprising:
after that the second collaboration agent device has decided to admit the participation in the selected session, notifying, by the second collaboration agent device, the second application of the participation of the first application in the selected session.

3. The method of claim 1, further comprising:
discovering, by the first collaboration agent device, that the first application is installed; and
notifying, by the first collaboration agent device, the registration of the first application to the second collaboration agent device.

4. The method of claim 2, wherein the first and second applications have information on collaboration sessions including information about their own applications and sessions in which the applications are able to participate.

5. The method of claim 1, further comprising:
when the first application is installed, requesting, by the first collaboration agent device, the first application of the collaboration session information;
receiving, by the first collaboration agent device, the collaboration session information from the first application; and
forwarding, by the first collaboration agent device, the collaboration session information to the second collaboration device.

6. The method of claim 1, further comprising:
detecting, by the first collaboration agent device, that the first application is removed from the smart device; and
notifying, by the first collaboration agent device, the deregistration of the first application to the second collaboration agent device.

7. The method of claim 1, further comprising:
when the first application is initiated, creating, by the first collaboration agent device, a session for the first application; and
notifying, by the first collaboration agent device, to the second collaboration agent device that the session in which the first application participates is created.

8. The method of claim 1, further comprising:
when the first application is completed, deleting, by the first collaboration agent device, the first application from the session to which the first application belongs; and
notifying, by the first collaboration agent device, the second collaboration agent device that the first application is deleted from the session in which the first application has participated.

9. The method of claim 1, further comprising:
when the first application requests to withdraw from a session to which the first application belongs, forwarding, by the first collaboration agent device, the request for a withdrawal of the first application from the session to the second collaboration agent device; and
when the second collaboration agent device decides the withdrawal of the first application from the session, forwarding, by the first collaboration agent device, the result of the withdrawal from the session to the first application.

10. The method of claim 2, further comprising:
requesting, by the first collaboration agent device, a passage of a message to the second application in accordance with the request of the passage of the message from the first application; and
notifying, by the first collaboration agent device, the result of the passage of the message.

11. A collaboration agent device installed in a smart device, the collaboration agent device being configured to:
provide a session list in which an application is able to participate to the sessions, wherein the application is installed in the same smart device;
forward, in accordance with a request from the application for a participation in a session selected from the session list, the request to other collaboration agent device, wherein the other collaboration agent device is installed in other smart device; and
receive a result of the request for the participation in the selected session from the other collaboration agent device which has decided to admit the participation in the selected session and notify the result of the request for the participation in the selected session to the application.

12. The collaboration agent device of claim 11, further comprising: a context management unit configured to store, migrate and recover a current state or a current context of the application.

13. The collaboration agent device of claim 11, further comprising: a lifecycle management unit configured to manage the current state of the application by classifying the current state in any one of a running state, paused state, a migrating state, and a stopped state.

14. The collaboration agent device of claim 11, further comprising: a migration management unit configured to manage the logical migration of the application from one smart device to other smart device.

15. The collaboration agent device of claim 11, further comprising: a package management unit configured to manage information about one or more applications installed in the smart device in which the collaboration agent device is equipped.

16. The collaboration agent device of claim 11, further comprising: a device management unit configured to manage information about the smart device in which the collaboration agent device is installed.

17. The collaboration agent device of claim 11, further comprising: a message management unit configured to manage that messages are passed between the application and other applications.

18. The collaboration agent device of claim 11, further comprising: a session management unit configured to manage information on sessions to which the application and other applications belong.

19. The collaboration agent device of claim 11, further comprising: a communication management unit configured to manage communications of the collaboration agent device with other collaboration agent devices.
